(19) United States
(12) Patent Application Publication
(10) Pub. No.: US 2006/0287435 A1
(43) Pub. Date: Dec. 21, 2006

(54) Thermoplastic compounds with flexible processing options for multi-applications

(75) Inventors: Xinhua He, Troy, MI (US); Michael W. Jary, Farmington Hills, MI (US); Srimannarayana Kakarala, Bloomfield Hills, MI (US); Suresh D. Shah, Troy, MI (US)

Correspondence Address: DELPHI TECHNOLOGIES, INC., M/C 480-410-202, PO BOX 5052, TROY, MI, 48007, US

(73) Assignee: Delphi Technologies Inc., Troy, MI (US)

(21) Appl. No.: 11/155,170

(22) Filed: Jun. 17, 2005

(51) Int. Cl. C08F 8/00

(52) U.S. Cl. 525/192

(57) ABSTRACT

A thermoplastic polyolefin composition containing polypropylene or a copolymer thereof, an ethylene copolymer, and a peroxide. In one embodiment, one of the polypropylene or copolymer thereof or the ethylene copolymer is a continuous phase, while the other is a discontinuous dispersed phase therein. In another embodiment, one of the polypropylene and ethylene copolymer components has a relatively low melt flow index and the other component has a relatively high melt flow index. Optional components include a metal stearate, a primary amide, a heat and/or light stabilizer, and a coloring additive. Articles molded from these thermoplastic compositions are also provided.

### TECHNICAL FIELD OF THE INVENTION

The present invention relates to a thermoplastic composition, a process for producing such composition and forming the composition into molded articles, and articles made therefrom.

### BACKGROUND OF THE INVENTION

Thermoplastic polymer compositions are being used in the automotive field for the fabrication of articles such as interior sheathing, panel skins, door panels, air bag doors and covers, roof liners, and seat covers. The articles may be produced from the polymer composition by extrusion, calendering, injection molding, thermoforming, etc. Many different thermoplastic materials have been developed depending on the different requirements for the automotive application. For example, a thermoplastic material for use as an air bag door, i.e., a door covering material where the door embodies a deployable air bag, will have different requirements than a thermoplastic material used for an instrument panel. An air bag door, for example, is required to perform deployment at all temperature conditions ranging from cold temperatures of about −30° C. or lower to hot temperatures of about +80° C. or higher. An air bag door is also required to have a good appearance and high resistance to scratch. Thus, for an air bag door, the thermoplastic material must meet multiple requirements, which are very different from each other. These multiple requirements pose a challenge in that current materials have difficulties meeting each of the different requirements. While the material may satisfy many of the requirements, it often has difficulties satisfying one or more other requirements.

In addition, the material properties affect the manufacturing process and the quality of the articles produced from those materials. For example, some materials can only be painted using a certain kind of painting material. Other materials require a special primer or a special painting process.

There is thus a need for thermoplastic materials having properties designed for flexible processing options for multiple applications, and that meet the multiple requirements for a given application. Using an air bag door as an example, a material is needed that is suitable for injection molding to produce a dimensionally stable article for a module assembly, that has properties that meet deployment requirements, and that can be mold-in-color or can use various painting systems and processes to achieve high quality of appearance. There is a further need for a thermoplastic composition having robust processing characteristics with respect to both material and/or manufacturing variations.

### SUMMARY OF THE INVENTION

The present invention provides a thermoplastic polyolefin composition and method of reactive extrusion compounding of the composition, the composition consisting essentially of, on the basis of total weight, about 55-80 wt. % of one of polypropylene (or a copolymer thereof) or an ethylene copolymer, about 20-45 wt. % of the other of polypropylene (or a copolymer thereof) or an ethylene copolymer, and a peroxide in an amount greater than zero and up to about 0.9 wt. %. Optional components include about 0-2 wt. % of a metal stearate, about 0-4 wt. % of a primary amide, about 0-1 wt. % of a heat stabilizer or a light stabilizer, or a combination thereof, and about 0-10 wt. % of a coloring additive. The present invention further provides articles molded from these thermoplastic compositions.

### DETAILED DESCRIPTION

As used herein, the term “about” modifies all numerical ranges, including both the lower and upper end points of the range, when the range is expressed as any one of: “about x-y,” “about x to about y”, or “between about x and about y.” The use of “about” indicates an intent not to be bound to strict numerical precision, but rather, such numerical ranges should be broadly construed.

The present invention provides a thermoplastic composition that can meet multiple requirements for automotive interior applications, such as air bag doors, knee bolsters, instrument panels, interior trim and liners, sheathing and covers, and can be amenable to various manufacturing processes, including but not limited to injection molding, gas-assisted injection molding, extrusion, compression molding, and the like.

To this end, a thermoplastic polyolefin composition is provided that consists essentially of polypropylene or a copolymer thereof, an ethylene copolymer, and a peroxide, and optionally a metal stearate, a primary amide, a heat and/or light stabilizer, and a coloring additive. In one embodiment of the present invention, a thermoplastic composition of the present invention may consist essentially of about 55-80 wt. % of a continuous phase, about 20-45 wt. % of a discontinuous dispersed phase, and some amount of peroxide greater than zero and up to about 0.9 wt. %. The continuous phase may be the polypropylene or copolymer thereof, in which case the discontinuous dispersed phase will be the ethylene copolymer. Alternatively, the continuous phase may be the ethylene copolymer, in which case the discontinuous dispersed phase will be the polypropylene or copolymer thereof. The remaining components are optional, but if included, the metal stearate, such as zinc stearate, may be present in an amount up to about 2 wt. %; the primary amide, such as erucamide, may be present in an amount up to about 4 wt. %; a heat or light stabilizer, or combination thereof, may be present in an amount up to about 1 wt. %; and a coloring additive may be present in an amount up to about 10 wt. %. In another embodiment of the present invention, the ethylene copolymer and polypropylene components may form a co-continuous phase, depending upon the ratio of the components and processing conditions. More particularly, if the ethylene copolymer and polypropylene components are relatively close in quantity and/or the peroxide level is high, the components may form a co-continuous phase.

With respect to the polypropylene component, in one embodiment, based upon the total weight of ingredients, polypropylene or a copolymer thereof is present in an amount of about 20 to about 45 wt. %, and in a further embodiment, it is present as a discontinuous dispersed phase in the ethylene copolymer. In another embodiment of the present invention, the polypropylene or copolymer thereof is present in an amount of about 55 to about 80 wt. %, and in a further embodiment, it is present as a continuous phase, with ethylene copolymer as a discontinuous dispersed phase therein. In yet another embodiment, polypropylene or a copolymer thereof is present in an amount of about 30 to about 40 wt. % as a discontinuous dispersed phase in the ethylene copolymer. In each of these embodiments, the polypropylene component may be a homopolymer.

In an exemplary embodiment, the polypropylene component has a melt flow index in the range of about 0.5-40 g/10 min., measured at 190° C. with a 2.16 kg weight, per ASTM D-1238. In a further exemplary embodiment, the polypropylene component has a melt flow index in the range of about 20-40 g/10 min. An example of a suitable, commercially available polypropylene for use in a thermoplastic composition of the present invention is PROFAX® SB891 by Basell, which has a melt flow index of about 30 g/10 min.

With respect to the ethylene copolymer, in one embodiment, based upon the total weight of ingredients, the ethylene copolymer is present in an amount of about 20 to about 45 wt. %, and in a further embodiment, it is present as a discontinuous dispersed phase in the polypropylene component. In another embodiment, the ethylene copolymer is present in an amount of about 55 to about 80 wt. %, and in a further embodiment, it is present as a continuous phase with the polypropylene component dispersed therein. In yet another embodiment, the ethylene copolymer is present in an amount of about 60 to about 70 wt. % as a continuous phase.

In an exemplary embodiment, the ethylene copolymer component has a melt flow index in the range of about 0.5-40 g/10 min., measured at 190° C. with a 2.16 kg weight, per ASTM D-1238. In a further exemplary embodiment, the ethylene copolymer has a melt flow index in the range of about 0.5-10 g/10 min. Examples of suitable, commercially available ethylene-octene copolymers for use in a thermoplastic composition of the present invention include ENGAGE® 8150, 8180, 8100 and 8200, which have low melt flow rates, and ENGAGE® 8400 and 8402, which have high melt flow rates, all of which are from DuPont Dow Elastomers L.L.C. Ethylene-butene copolymers, for example, may also be suitable for use in the present invention.

In an exemplary embodiment of the present invention, both the polypropylene component and the ethylene copolymer component have a melt flow index in the range of about 0.5-40 g/10 min., measured at 190° C. with a 2.16 kg weight, per ASTM D-1238, but one component has a melt flow index at the lower portion of the range and the other component has a melt flow index at the upper portion of the range. For example, the composition may include polypropylene having a melt flow index of about 0.5-20 g/10 min. and an ethylene copolymer having a melt flow index of about 20-40 g/10 min. In a further example, the composition may include polypropylene having a melt flow index of about 0.5-10 g/10 min. and an ethylene copolymer having a melt flow index of about 20-40 g/10 min. Alternatively, the composition may include an ethylene copolymer having a melt flow index of about 0.5-20 g/10 min. and polypropylene having a melt flow index of about 20-40 g/10 min. In a further alternative, the composition may include an ethylene copolymer having a melt flow index of about 0.5-10 g/10 min. and polypropylene having a melt flow index of about 20-40 g/10 min.

In another exemplary embodiment, one of the polypropylene and ethylene copolymer components has a melt flow index of about 0.5-20 g/10 min. and is present in an amount of about 55 to about 80 wt. % as a continuous phase, and the other has a melt flow index of about 20-40 g/10 min. and is present in an amount of about 20 to about 45 wt. % as a discontinuous dispersed phase. In a further exemplary embodiment, one of the polypropylene and ethylene copolymer components has a melt flow index of about 0.5-10 g/10 min. and is present in an amount of about 55 to about 80 wt. % as a continuous phase, and the other has a melt flow index of about 20-40 g/10 min. and is present in an amount of about 20 to about 45 wt. % as a discontinuous dispersed phase. In a yet further exemplary embodiment of the present invention, the composition may include an ethylene copolymer having a melt flow index of about 0.5-10 g/10 min. in an amount of about 60 to about 70 wt. % as a continuous phase, and polypropylene having a melt flow index of about 20-40 g/10 min. in an amount of about 30 to about 40 wt. % as a discontinuous dispersed phase in the ethylene copolymer.

With respect to the peroxide, it is not an optional component, and therefore is present in some amount, although a lower limit is not provided because even very small amounts are effective. Thus, peroxide is present in an amount greater than zero and up to about 0.9 wt. %, based upon the total weight of ingredients. In one embodiment, the peroxide is present in an amount of about 0.05-0.9 wt. %. In another embodiment, the peroxide is present in an amount of about 0.3 to about 0.9 wt. %. Peroxide is useful for rheology modification by side chain branching or by cross-linking in a thermoplastic composition of the present invention. Peroxides suitable for use in the present invention include but are not limited to 1,1-di-t-butyl peroxy-3,3,5-trimethylcyclo-hexane; dicumyl peroxide; methyl ethyl ketone peroxide; 2,5-dimethyl-2,5-di {t-butyl peroxy} hexane; t-butyl-cumyl peroxide; di-t-butyl peroxide; 2,5-dimethyl-2,5-di-{t-butyl peroxy} hexyne; t-butylperoxyisopropyl carbonate; cumene hydroperoxide; di-t-butyl peroxyphthalate; and the like, as well as combinations thereof. One example of a commercially available peroxide suitable for use in a thermoplastic composition of the present invention is VAROX®-P20 from R. T. Vanderbilt Co.

With respect to the metal stearate, it is an optional component, and may be present in an amount up to about 2 wt. % based upon the total weight of ingredients. In one embodiment, the metal stearate is present in an amount of about 0.5-1.5 wt. %. In another embodiment, the metal stearate is present in an amount of about 1 wt. %. Metal stearates can be useful as lubricants, acid scavengers, stabilizers, mold release agents, flow agents, and/or processing aids for a thermoplastic composition of the present invention. In an exemplary embodiment, the metal stearate is zinc stearate, which acts as a mold release agent and processing aid, as well as an acid scavenger, which in turn contributes to color stability in the thermoplastic composition. In other exemplary embodiments, the metal stearate may be calcium stearate, potassium stearate, aluminum stearate or sodium stearate, as well as combinations thereof, such as a zinc stearate/calcium stearate blend. One example of a commercially available zinc stearate suitable for use in a thermoplastic composition of the present invention is Product No. RSN131HS Granular from Baerlocher USA, LLC.

With respect to the primary amide, it is an optional component, and may be present in an amount up to about 4 wt. % based upon the total weight of ingredients. In one embodiment, the primary amide is present in an amount of about 0.1-2.5 wt. %. In another embodiment, the primary amide is present in an amount of about 2 wt. %. Primary amides are made from long chain fatty acids by amidation, and are useful as slip agents, i.e., friction-reducing agents, for processing of the thermoplastic compositions of the present invention, and in particular, are useful for injection molding the compositions. In an exemplary embodiment, the primary amide is erucamide, which is prepared by amidation of erucic acid. In other exemplary embodiments, the primary amide may be stearamide, prepared by amidation of stearic acid, or oleamide, prepared by amidation of oleic acid. One example of a commercially available erucamide suitable for use in a thermoplastic composition of the present invention is ATMER® SA1753 by Uniqema and available through Ciba Specialty Chemicals.

With respect to heat and/or light stabilizers, they are optional components, and may be present in an amount up to about 3 wt. % based upon the total weight of ingredients. In an exemplary embodiment, a UV and/or heat stabilizer may be present in an amount greater than zero and up to about 1 wt. %. Heat stabilizers include phenolics, hydroxylamines, phosphates, phosphites, and the like, as well as combinations thereof. Light stabilizers include low molecular weight (having number-average MWs less than about 1000) hindered amines, high molecular weight (having number-average MWs greater than about 1000) hindered amines, and the like, as well as combinations thereof. In an exemplary embodiment, the stabilizer may be a UV absorber, which shields the thermoplastic composition from ultraviolet light, or a hindered amine light stabilizer, which scavenges radical intermediates formed in a photo-oxidation process. Examples of commercially available stabilizers suitable for use in a thermoplastic composition of the present invention are available from Ciba Specialty Chemicals.

With respect to the coloring additive, it is an optional component, and may be present in an amount up to about 10 wt. % based upon the total weight of ingredients. The coloring additive may be a color concentration, a pigment, a dye, or the like, or any combination thereof. In an exemplary embodiment, a color concentration may be used in an amount of about 1-5 wt. %, for example about 3-4 wt. %. Examples of commercially available color concentrates suitable for use in a thermoplastic composition of the present invention are Product Nos. 54092-H1 and 43553-X1 from AmeriChem, Inc. The coloring additive may be introduced into the composition of the present invention in a polymer carrier, such as in a polypropylene carrier, an ethylene copolymer carrier or a polyethylene carrier, such as a linear low density polyethylene, to assist in distribution of the component in the composition. The heat and/or light stabilizer may also be introduced in the polymer carrier. The presence of the polymer carrier for introducing the coloring additive, heat stabilizer and/or light stabilizer is not precluded from the scope of the invention by the language “consisting essentially of.”

The thermoplastic compositions of the present invention may be formed by various techniques, including melt blending, such as under high shear conditions; in-line compounding; extruding; in-line thermoforming; calendering; and the like, as well as combinations thereof. The production techniques can be accomplished by employing conventional equipment, such as extruders, mixers, kneaders, compounders, and the like. Suitable extruders include twin screw or single screw extruders. A well-suited extruder has a L/D (length of screw/barrel diameter) ratio of greater than 28:1 and further includes dispersive and distributive mixing capability. The components may be introduced into the extruder through a single feed or through multiple feeds. An example of a suitable compounder is a twin screw compounder Model ZSE40HP/600 and ZSE40HP 6L/36D by Leistritz. The compounding ingredients may be tumble mixed by a ribbon blender and fed into a twin screw extruder having a mixing screw configuration to provide high distributive mixing at low shear, and a residence time between about 30 to about 45 seconds. The compounding conditions in the suitable twin screw compounder may be as follows, including an exemplary range, as well as a specific example within the exemplary range:

TABLE I

Setting/Monitoring

| Condition | Unit | Exemplary Range | Example |
|---|---|---|---|
| Zone Temperature | ° C. | about 180-225 | about 190 |
| ZSE Load | % | about 30-50 | about 42 |
| Pressure | psi | about 1000-2000 | about 1680 |
| Melt Temperature | ° C. | about 150-200 | about 176 |
| Feed Rate | lb/hr | about 150-250 | about 230 |
| Screw Speed | rpm | about 200-400 | about 350 |

These parameters along with selection of ingredients will help in obtaining the final morphology and properties without beta-scission of polypropylene (i.e., without reducing the molecular weight of PP). Another suitable machine for processing compositions of the present invention is an inline compounding/reactive extrusion with extrusion compression molding press available from Dieffenbacher. In an exemplary embodiment, the thermoplastic composition may be produced with a common screw extruder or compounder machine, and in particular, the composition may be compounded with a twin screw extruder or compounder using a mixing screw configuration, followed by injection molding.

In an exemplary embodiment, the thermoplastic composition, when formed, has properties particularly suitable for injection molding. To that end, the melt flow index at 190° C. may be in the range of about 0.5-10.0 g/10 min with a 2.16 kg load and in the range of about 5-100 g/10 min with a 10 kg load, per ASTM D-1238. In an exemplary embodiment, the melt index for the same temperature and loads may be about 0.5-5 g/10 min and about 10-70 g/10 min, respectively. For injection molding, the shrinkage rate for the thermoplastic composition may be about 0.05-2.5%, per ASTM D-955. In a further exemplary embodiment, the shrinkage rate may be about 0.4-1.6%. The tensile stress at 100% elongation may be in the range of about 500-2000 psi, per ASTM D-1708. In a further exemplary embodiment, the tensile stress at 100% elongation is about 800-1600 psi. The ultimate elongation may be about 400-800%, per ASTM D-1708. These properties are relevant to cold temperature performance, low gloss, and improved surface appearance without tear seam readout for airbag applications. One example of an injection molding machine suitable for use in forming articles from the thermoplastic compositions of the present invention is a Van Dorn 385 ton machine.

In addition to injection molding, articles may be formed from the thermoplastic compositions of the present invention by extrusion, compression molding, or other like processes. For producing air bag doors, injection molding is particularly suitable. These articles may be molded-in-color, coated with a clear or colored coating, or painted with a solvent-based or water-based paint system. Thus, the properties of the thermoplastic compositions of the present invention are versatile with respect to the various processing techniques that may be used to achieve the desired appearance of the molded article. In addition, the molded articles have robust properties that meet air bag deployment requirements in addition to meeting the appearance requirements. The molded articles for air bag doors have good appearance in the tear seam area, enhanced performance at low temperatures, and they are compatible with a wide range of painting systems. Thus, molded articles from the thermoplastic compositions of the present invention meet multiple requirements demanded by various automotive applications, such as air bag doors.

### EXAMPLES

The following examples were prepared by compounding the materials in a twin screw compounder/extruder to produce a feedstock in bead/pellet form. The compounding conditions were within the exemplary ranges provided in Table I above. Molded articles were then produced from the feedstock by injection molding. The compositions, in weight percent, are set forth in Table II, and the properties of the thermoplastic compositions are provided in Table III.

TABLE II

| | | COMPOUND | | | | | | |
|---|---|---|---|---|---|---|---|---|
| | | A | B | C | D | E | F | G |
| Ethylene | I¹ | 40 | 60 | 60 | — | — | 65 | 65 |
| Copolymer | II² | — | — | — | 70 | 70 | — | — |
| Polypropylene³ | | 60 | 40 | 40 | 30 | 30 | 35 | 35 |
| Color | III⁴ | 4 | 4 | 4 | 4 | — | 4 | 4 |
| Concentrate & | IV⁵ | — | — | — | — | 4 | — | — |
| Stabilizer | | | | | | | | |
| Package | | | | | | | | |

| | | | | | | | |
|---|---|---|---|---|---|---|---|
| Peroxide | 0.4 | 0.6 | 0.6 | 0.9 | 0.9 | 0.3 | 0.6 |
| (VAROX ®-P20) | | | | | | | |
| Erucamide | 2.0 | — | 2.0 | — | 2.0 | — | — |
| (ATMER ® SA1753) | | | | | | | |
| Zinc Stearate | 1.0 | 1.0 | 1.0 | 1.0 | 1.0 | 1.0 | 1.0 |

¹ENGAGE ® 8150 having a comonomer content of 39 wt. %, and a melt flow index of about 0.5 g/10 min (190° C., 2.16 kg).
²ENGAGE ® 8180 having a comonomer content of 42 wt. %, and a melt flow index of about 0.5 g/10 min (190° C., 2.16 kg).
³PROFAX ® SB891 having a melt flow index of about 30 g/10 min (190° C., 2.16 kg).
⁴Black color concentrate in a linear low density polyethylene (LLDPE) carrier with <1 wt. % being a UV + heat stabilizer package.
⁵Black color concentrate in an ethylene copolymer (ENGAGE ® blend) carrier with <1 wt. % being a UV + heat stabilizer package.

TABLE III

| PROPERTY | UNIT | A | B | C | D | E | F | G |
|---|---|---|---|---|---|---|---|---|
| Tensile Stress @ 10% Elongation | [psi] | 1335 | 914 | 1004 | 504 | 234 | 687 | 681 |
| Tensile Stress @ 100% Elongation | [psi] | 1765 | 1573 | 1607 | 1220 | 803 | 1398 | 1377 |
| Tensile Strength at Break | [psi] | 1904 | 2142 | 2196 | 1616 | 1571 | 2148 | 2037 |
| Ultimate Elongation | [%] | 367 | 680 | 675 | 601 | 896 | 746 | 715 |
| Melt Flow Rate (2.16 kg @ 190° C.) | [g/10 min] | — | 2.4 | 4.4 | 1.1 | 0.7 | 3.6 | 2.2 |
| Melt Flow Rate (10.0 kg @ 190° C.) | [g/10 min] | — | 37.8 | 76.0 | 21.6 | 14.2 | 55.3 | 30.7 |
| Scratch and Mar Resistance⁶ | Ranking | 14 | 12-14 | 12-14 | — | 14 | — | 13 |
| Initial Appearance Quality⁷ | Ranking | 3-5 | 3-5 | 3-5 | 3-5 | 3-5 | 3-5 | 3-5 |
| Optimized Appearance Quality⁷ | Ranking | — | — | — | — | — | — | 1 |
| Deployment Performance⁸ | Ranking | 9 | — | 3 | — | 3 | — | 1 |
| ⁶The scratch resistance performance was measured using a five-finger scratch tester per Ford FLTM-BN-108-13 specification (Rev. 5/1/1995). The ranking is derived from the summation of five scratch readings of 1 mm pin with five different loads ranging from 8.5 to 20 Newtons. The lower the ranking number; the better the scratch resistance. | | | | | | | | |
| ⁷The initial appearance quality at the tear seam is based upon screening molding trials. The optimized molding parameters were used for Formulation G. The molding parameters were optimized with a given prototype tool. The optimized parameters included the tool temperature at 80° F.; the packing pressure at 835 psi; the packing time at 10 seconds; and the injection speed at 3.9 inches per second. This optimization | | | | | | | | |
| # demonstrates the potential to improve the tear seam appearance for the other formulations. | | | | | | | | |
| ⁸The deployment performance was rated based upon the test results of high-speed deployment at hot (80° C.) and cold (−30° C.) temperatures. The deployment performance is relative to air bag cover design, molding process settings, and test conditions. The tear seam design has an influence on the deployment performance. The deployment performance requirements are that no fragmentation and no under deployment | | | | | | | | |
| # (tear seam is not torn along the total length) or over deployment (tear extends past the designed tear seam) occur when tested at all required temperature conditions. Rating 1 means the deployment performance exceeded the requirement. Rating 3 means the deployment performance met the requirement. Rating 9 means the deployment performance was marginal and/or less than desired. The lower the ranking number, the better the deployment performance. | | | | | | | | |

The testing shows that compositions of the present invention exhibit properties particularly suitable for injection molding, including having melt flow rates, tensile strengths, and ultimate elongations in the desired ranges. In addition, molded deployable air bag covers made from Compounds B-G passed deployment tests at −30° C. or below and at +80° C. In addition, five different painting processes were applied to the molded covers, and all produced a suitable appearance. For Compound A, the deployment performance rated a 9 at the particular design and molding conditions used. However, the optimum design and molding conditions may differ for some embodiments of the invention. Compound A requires the air bag cover to be designed with optimized tear seam geometry and additional features, such as reinforcing ribs or increased thickness at hinge areas. It is also recommended to have a design feature at the end of the tear seam to stop the propagation of tear (for example, change in tear seam direction). So, it is believed that routine experimentation in which one or more parameters are altered will yield appropriate design and molding conditions for Compound A to achieve a better deployment performance.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. A thermoplastic polyolefin composition consisting essentially of, on the basis of total weight:
polypropylene or a copolymer thereof as a first component,
an ethylene copolymer as a second component,
wherein one of the first or second components is present in an amount of about 55-80 wt. % and the other of the first or second components is present in an amount of about 20-45 wt. %,
a peroxide in an amount greater than zero and up to about 0.9 wt. %,
about 0-2 wt. % of a metal stearate,
about 0-4 wt. % of a primary amide,
about 0-3 wt. % of a heat stabilizer or a light stabilizer, or a combination thereof, and
about 0-10 wt. % of a coloring additive.

2. The thermoplastic polyolefin composition of claim 1 wherein the ethylene copolymer is present in the amount of about 55-80 wt. % as a continuous phase and the polypropylene or copolymer thereof is present in the amount of about 20-45 wt. % as a discontinuous dispersed phase.

3. The thermoplastic polyolefin composition of claim 2 wherein the ethylene copolymer has a melt flow index of about 0.5-20 g/10 min. measured at 190° C. with a 2.16 kg weight, and the polypropylene or copolymer thereof has a melt flow index of about 20-40 g/10 min. measured at 190° C. with a 2.16 kg weight.

4. The thermoplastic polyolefin composition of claim 2 wherein the ethylene copolymer has a melt flow index of about 0.5-10 g/10 min. measured at 190° C. with a 2.16 kg weight, and the polypropylene or copolymer thereof has a melt flow index of about 25-40 g/10 min. measured at 190° C. with a 2.16 kg weight.

5. The thermoplastic polyolefin composition of claim 2 wherein the ethylene copolymer is present in an amount of about 60-70 wt. % and the polypropylene or copolymer thereof is present in an amount of about 30-40 wt. %.

6. The thermoplastic polyolefin composition of claim 1 wherein the polypropylene or copolymer thereof is present in the amount of about 55-80 wt. % as a continuous phase and the ethylene copolymer is present in the amount of about 20-45 wt. % as a discontinuous dispersed phase.

7. The thermoplastic polyolefin composition of claim 6 wherein the polypropylene or copolymer thereof has a melt flow index of about 0.5-20 g/10 min. measured at 190° C. with a 2.16 kg weight, and the ethylene copolymer has a melt flow index of about 20-40 g/10 min. measured at 190° C. with a 2.16 kg weight.

8. The thermoplastic polyolefin composition of claim 6 wherein the polypropylene or copolymer thereof has a melt flow index of about 0.5-10 g/10 min. measured at 190° C. with a 2.16 kg weight, and the ethylene copolymer has a melt flow index of about 25-40 g/10 min. measured at 190° C. with a 2.16 kg weight.

9. The thermoplastic polyolefin composition of claim 1 wherein the peroxide is present in an amount of about 0.05-0.9 wt. %.

10. The thermoplastic polyolefin composition of claim 1 wherein the peroxide is present in an amount of about 0.3-0.9 wt. %.

11. The thermoplastic polyolefin composition of claim 1 wherein the composition has a melt flow index of about 0.5-10 g/10 min. measured at 190° C. with a 2.16 kg weight, and about 5-100 g/10 min. measured at 190° C. with a 10 kg weight.

12. The thermoplastic polyolefin composition of claim 1 wherein the composition has a shrinkage rate of about 0.05-2.5%, and a tensile strength at 100% elongation of about 500-2000 psi.

13. A molded air bag door made by injection molding the thermoplastic polyolefin composition of claim 1.

14. A thermoplastic polyolefin composition consisting essentially of, on the basis of total weight:
a continuous phase of about 55-80 wt. % of an ethylene copolymer having a melt flow index of about 0.5-10 g/10 min. measured at 190° C. with a 2.16 kg weight,
a discontinuous dispersed phase of about 20-45 wt. % polypropylene or a copolymer thereof having a melt flow index of about 20-40 g/10 min. measured at 190° C. with a 2.16 kg weight,
about 0.05-0.9 wt. % of a peroxide,
about 0-1.5 wt. % of a zinc stearate,
about 0-4 wt. % of an erucamide,
a heat stabilizer or a light stabilizer, or a combination thereof, in an amount greater than zero and up to about 1 wt. %, and
about 1-5 wt. % of a coloring additive.

15. The thermoplastic polyolefin composition of claim 14 wherein the polypropylene or copolymer thereof is present in an amount of about 30-40 wt. %, and wherein the ethylene copolymer is present in an amount of about 60-70 wt. %.

16. The thermoplastic polyolefin composition of claim 14 wherein the peroxide is present in an amount of about 0.3-0.9 wt. %.

17. The thermoplastic polyolefin composition of claim 14 wherein the composition has a melt flow index of about 0.5-10 g/10 min. measured at 190° C. with a 2.16 kg weight, and about 5-100 g/10 min. measured at 190° C. with a 10 kg weight.

18. The thermoplastic polyolefin composition of claim 14 wherein the composition has a shrinkage rate of about 0.05-2.5%, and a tensile modulus at 100% elongation of about 500-2000 psi.

19. A molded air bag door made by injection molding the thermoplastic polyolefin composition of claim 14.

20. A method of processing the composition of claim 1, comprising:
compounding the composition in a twin screw compounder for 30-45 seconds residence time at a zone temperature of about 180-225° C., a percentage load of about 30-50%, a screw speed of about 200-400 rpm, a pressure of about 1000-2000 psi, a feed rate of about 150-250 lb/hr, and a melt temperature of about 150-200° C. to form a compounded material, and
injection molding the compounded material to form a molded article.

21. A method of processing the composition of claim 14, comprising:
compounding the composition in a twin screw compounder for 30-45 seconds residence time at a zone temperature of about 180-225° C., a percentage load of about 30-50%, a screw speed of about 200-400 rpm, a pressure of about 1000-2000 psi, a feed rate of about 150-250 lb/hr, and a melt temperature of about 150-200° C. to form a compounded material, and
injection molding the compounded material to form a molded article.
